(19) United States
(12) Patent Application Publication
(10) Pub. No.: US 2010/0300181 A1
(43) Pub. Date: Dec. 2, 2010

(54) Metering Station and Process for Metering Highly Viscous Liquids

(75) Inventors: Torsten Zech, Heidelberg (DE); Gunilla Kaiser, Leimen (DE); Uwe Vietze, Eppelheim (DE); Volker Mathes, Heidelberg (DE); Frank Guellich, Sandhausen (DE)

Correspondence Address: THE FIRM OF HUESCHEN AND SAGE, SEVENTH FLOOR, KALAMAZOO BUILDING, 107 WEST MICHIGAN AVENUE, KALAMAZOO, MI, 49007, US

(73) Assignee: HTE AKTIENGESELLSCHAFT THE HIGH THROUGHPUT EXPERIMENTATION COMPANY, Heidelberg (DE)

(21) Appl. No.: 12/223,842

(22) PCT Filed: Feb. 9, 2007
(86) PCT No.: PCT/EP2007/001116

§ 371 Date: Aug. 16, 2010

(30) Foreign Application Priority Data
Feb. 10, 2006 (DE) 10 2006 006 288.4

(51) Int. Cl. G01N 11/00

(52) U.S. Cl. 73/54.01

(57) ABSTRACT

The present invention relates to a metering station (10) which allows liquids with elevated viscosity to be metered, especially liquids with a viscosity which is more than one hundred times the viscosity of water. The metering station is operated partly or fully automatically and has a modular structure. A metering module (1, 1′) comprises at least one plug connecting element (8), with whose aid the metering module (1, 1′) can be made to engage with a corresponding receiving device (9) for the plug connecting element. The plug connecting elements (8) are preferably multifunctional plugs which have at least one fluidic connecting element. In a further preferred embodiment, the plug connecting element (8), in addition to the at least one fluidic connecting element, also has at least one electrical connecting element for process control. The present invention further relates to a process which allows, in a very flexible manner and with a very high throughput, a multitude of (optionally different) components which have an elevated viscosity to be metered into a sampling vessel. The process uses a metering algorithm which is tailored to the high-throughput metering of liquids of elevated viscosity.

The present invention relates to a metering station and a process for the metering of highly viscous liquids.

The manufacture of new materials, in particular of substance formulations as well as the optimization of already known, substance formulations that are composed of a plurality of different components, is of high importance in many technical fields. In many application fields, e.g. in the manufacture of pharmaceuticals, cosmetics, plastics, colored mixtures, adhesives, foodstuffs, etc., it is required that a desired substance formulation may be produced by means of suitable metering methods with a high accuracy within a very short time from a high number of different liquids.

The different liquid and, if necessary, also at least partially solid starting components, which are to be metered for producing a complex substance formulation, often have different characteristics, in particular with regard to their density and viscosity. Thus, conventional devices and methods for metering liquids having low viscosity, in particular having the viscosity of water or aqueous solutions, are not suitable for producing substance formulations, which at least should have a liquid having a medium or a high viscosity. In particular, pipetting automats are not suitable for metering liquids having medium or high viscosity.

Regarding the metering of liquids having a higher or high viscosities, it is common to transfer these liquids from a supply region into a receiving container by subjecting compressed gas.

For example, WO 03/047737 A1 describes a device for metering liquid components, which consists of a certain number of different storage containers filled with liquids. At first, an inert gas is fed to the individual storage containers, which develops within each of these individual containers a defined overpressure. Thereby, each individual storage container has an outgoing pipe provided with a control valve, the outgoing pipe is provided above a synthesis container being located on a scale. With the aid of a process control, both the opening time of the control valve and the weight increase in the applied synthesis container is registered by receiving liquid from the storage container. When using correspondingly short switching times for the opening of the valve in connection with a stepwise control of the weight increase, predetermined amounts of highly viscous liquid can be transferred into the synthesis container in a controlled manner.

WO 03/047737 substantially is directed to the precise recording and logging of the amount of a component to be metered in each sub-step. With regard to the arrangement and design of the storage container for the individual components, only few is disclosed.

One of the objects according to the invention consists therein to provide a metering station, which allows to meter liquids having an increased viscosity, in particular to meter liquids having a viscosity of more than hundredfold of the viscosity of water. Thereby, the metering station is to be partially or completely automatically operated, and also simultaneously should have a high flexibility with regard to the amount and/or type of the substances to be metered, and in particular should allow to combinatorial produce a plurality of different substance formulations in a high throughput. Furthermore, the metering station should have dimensions as small as possible and should be inexpensively and versatility employable.

Furthermore, a process should be provided, which allows metering a plurality of (if necessary different) components with throughput as high as possible into a receiving container for samples. Also, the process should allow metering at least two different components, if necessary in different amount ratios, into two or more different receiving containers for samples, so that at least two or more different substances or substance formulations can be manufactured in parallel respectively can be mixed.

The metering station according to the invention respectively the process according to the invention should be suitable for the high throughput formulation of highly viscous liquids, that is should allow a fast filling/metering of liquids having an increased viscosity.

The term “liquids” as used in the meaning of the present invention relates to all liquids whose viscosity is in a range of from 0.5 mPa·s to 400 Pa·s, preferably in a range of from 1 mPa·s to 100 Pa·s, further preferred in a range of from 100 mPa·s to 40 Pa·s, further preferred in a range of from 100 mPa·s to 10 Pa·s, measured at 20° C., respectively. In the meaning of the present invention, non-Newtonian liquids, dispersions, suspensions, oils, lubricants and pastes thereby are also “liquids”. “Highly viscous” liquids or “liquids having an increased viscosity” in the meaning of the present invention, have a viscosity higher than water, preferably more than 5 mPa·s, further preferred more than 50 mPa·s, further preferred more than 100 mPa·s, further preferred more than 500 mPa·s, further preferred more than 1 Pa·s.

The objects mentioned here and further objects are thereby solved that a metering station (10) for metering at least one liquid having an increased viscosity is provided, the metering station being composed of modular elements.

In one embodiment, the metering station (10) according to the invention comprises:
at least four metering modules (1, 1′);
at least one support (7) for receiving the at least four metering modules (1, 1′);
at least one scale (12) for receiving different receiving containers for samples; and
a process control.

In another embodiment according to the present invention, the metering station (10) for metering at least one liquid having an increased viscosity comprises at least:
at least four metering modules (1, 1′) comprising at least one metering module comprising a liquid having an increased viscosity and comprising at least two metering modules comprising different liquids;
at least one support (7) for receiving the at least four metering modules (1, 1′), wherein the support can simultaneously be an automated unit for positioning;
at least one automated unit for positioning the at least four metering modules, which can either be the support (7) or a unit for positioning independent from said support;
at least one scale (12) for receiving receiving containers for samples; and a process control.

Thereby, it is preferred that each metering module (1, 1′) is connected with the support (7) via a connection assembly element.

As “scale” (12) in the meaning of the present invention, each element or module has to be regarded, which is suitable for determining the weight of a liquid within a receiving container for samples. No restrictions exist with regard to the objective design of the scale. The specific type for determining the weight is without importance in the scope of the present invention as long as all in all a weight change can be registered by the process control. A “fast” scale, that is a unit for measuring a weight change within a fast reaction time concerning such a weight change is preferred in the scope of the present invention.

For the parallel manufacture of more than one substance formulation, in a preferred embodiment, more than one scale (12) per metering station (10) can be employed. In a further embodiment, also more than one receiving container for samples can be located on one scale. In this case, a weight change in the two or more receiving containers for samples is sequentially determined on the one scale.

The scale (12) respectively also the scales (12) preferably comprise a movable housing respectively a cover (13), which shields the balancing plate and the container for receiving the liquid located on it from air movements in the surrounding of the device respectively reduces disturbing influences caused by these air movements or other environmental influences. Said movable housing is preferably designed such that it has on its upper side an opening, whereby the receiving container for samples is arranged below this opening, and the liquid can be metered from the metering head through the opening into the receiving container for samples. Preferred scales (12) are laboratory scales having high resolution, whose measure range e.g. is in a range of from 0 to 600 g, preferably 0 to 300 g, and which have a resolution of ±0.1 mg or better.

According to the invention, the support (7) serves to receive at least four metering modules (1, 1′).

According to a preferred embodiment of the present invention, the support (7) does not only serve for receiving at least four metering modules (1, 1′) but also for positioning said at least four metering modules (1, 1′) in relation to the receiving container for samples, or in relation to another target point, a metering module is to be moved to. In the meaning of this embodiment, the support (7) is a “unit for positioning” in the meaning of the present invention, i.e. is movable in at least one space direction.

In the scope of the present invention, it is important that more than two metering modules (1, 1′) are present. Thereby, the exact number of employed metering modules is not important for the function of the present invention. More than 4, 6, 8, 12, 16, 24, 48 etc. metering modules (1, 1′) can be present in parallel within one support (7). Preferably, said metering modules (1, 1′) are filled with different liquids, which may be considerably different with regard to their viscosity. Due to the fact that different liquids are present in different metering modules, and due to the fact that these can be moved from one point in space to another point in space, a variety of different substance formulations can be automatedly produced in a fast manner and/or with high throughput.

In a further preferred embodiment according to the present invention, the metering station (10) additionally comprises to a support, which also functions as a unit for positioning, at least one further unit for positioning. This at least one further unit for positioning is preferably suitable to move either at least one metering module (1, 1′) from one point in space to another point in space, or at least one receiving container for samples from one point in space to another point in space. The unit for positioning can also be suitable to simultaneously carry out both positioning steps or in sequence and/or move any further modules or elements of the metering station from one point in space to another point in space.

A unit for positioning can be suitable for displacements in two space directions (“x-y-positioning unit”), or in three space directions (“x-y-z-positioning unit). The movements of the unit for positioning may be linear or circular, respectively, or can be composed of sequences thereof. A preferred unit for positioning is a gripping device, that is a positioning robot having a gripping arm. Depending on the positioning problem, the gripping arm can variably be selected and/or exchanged.

With the aid of said gripping device, the same but also different receiving containers for samples can be moved from their locations to the scale (12), and from the scale to their locations. Furthermore, the automated gripping device can (additionally) be used for the equipment of the individual locations of the support (7) with metering modules (1, 1′), or for the exchange of metering modules (1, 1′) on the locations of the support (7), or for all of the aforementioned operations.

In a preferred embodiment, the gripping device is designed such that it can manipulate different metering modules (1, 1′) with regard to their form and also with regard to their size, as well as it can also additionally manipulate receiving containers for samples being different with regard to their form and/or size. If necessary, it may be required and/or meaningful to exchange the gripper of a gripping device between two operations, e.g. in the transfer of an operation “insertion of a particularly large metering module (1, 1′)″ to a predetermined location in the support (7)” to an “exchange of a particularly small receiving container for samples on the scale (12)”.

According to a preferred embodiment of the present invention, said metering module (1, 1′) is positioned from the support and/or a unit for positioning in relation to a receiving container for samples such that the liquid to be metered flows in gravitation direction into said receiving container for samples when opening the respective metering module (1, 1′). Therefore, preferably, the metering module (1, 1′) is positioned above the receiving container for samples.

The receiving container for samples according to the present invention is suitable to receive at least one of the metered liquids. Furthermore, the receiving container for samples is suitable to receive a solid to be metered, if necessary. No restrictions exist with regard to the material and the design of the receiving container for samples. In particular, in the meaning of the present invention, it is not necessary that the receiving containers for said samples have all the same form, but also rather differently designed or differently large receiving containers for samples can be employed. No restrictions exist with regard to the material, the receiving container for samples is produced, as long as said material is chemically and physically compatible with the components to be metered, and also in particular is suitable with regard to the released mixing enthalpy of chemical reactions when mixing two or more components.

In a preferred embodiment, within the meaning of the modular design of the whole metering station (10), also the metering module (1, 1′) is modularly arranged, that is at least two components of the metering module (1, 1′) can be detached from each other and can be reconnected with each other, respectively can be replaced by another component. In a preferred embodiment, individual components of different metering modules can be exchanged by each other.

In a preferred embodiment, metering module (1, 1′) comprises at least one metering point (2), metering head (3) and one storage container (5). Metering point, metering head and storage container are in fluidic connection.

In a preferred embodiment, metering point (2), metering head (3) and storage container (5) are modularly exchangeable, respectively. However, it is in complete accordance with the present invention, if metering point (2), metering head (3) and storage container (5) are integrally formed with each other. Between metering point (2), metering head (3) and storage container (5) also any continuous transition can exist as long as the functionalities “unit for receiving a liquid having an increased viscosity”, “unit for opening and closing the connection passage of the liquid through a channel for metering a liquid having an increased viscosity” and “channel” are fulfilled within one metering module (1, 1′). In the scope of the whole disclosure and in particular in the meaning of the patent claims, the term “storage container (5)” is to be interchangeably used with “unit for receiving a liquid having an increased viscosity”, “metering head” is to be interchangeably used with “unit for opening and closing the connection passage of liquid through a channel for metering a liquid having an increased viscosity”, and “metering point (2)” is to be interchangeably used with “channel”, except this is differently indicated in connection with a particular embodiment.

The metering point (2) comprises at least one channel preferably having a circular inner diameter through which the liquid to be metered must pass through in order to exit the metering module. Although the channel should preferably have a circular inner diameter, also any other geometry regarding the inner diameter of such a channel is possible, e.g. an elliptical or a polygonal geometry, as long as liquid can finally be metered from the metering module outwards through the channel by means of subjecting pressure.

In one embodiment, the channel of the metering point runs conically from inwards to outwards, that is the inner diameter decreases across the length of the channel. In another embodiment, the inner diameter remains constant across the length of the channel.

No restrictions exist regarding the length of the channel of the metering point as well as regarding the absolute value of the inner diameter, as long finally liquids can be metered outwards from the metering module through the channel by subjecting pressure. The higher the viscosity of the liquid, logically the higher is the inner diameter of the “channel”.

In a preferred embodiment, the metering module (1, 1′) at least comprises an exchangeable metering point (2).

It is preferred that the selection of a metering point (2) being suitable for the metering of a particular liquid occurs in the scope of a calibration step respectively occurs based on the analysis of a calibration step (see the process steps set forth below).

According to a preferred embodiment of the present invention, the metering head (3) serves for receiving a valve, or is said valve, wherein said valve serves to control the metering of the liquid. In “closed state” of the valve, no liquid is allowed to pass through the metering point (2). In “opened state” of the valve, in contrast, when applying pressure, liquid should be allowed to pass through the metering point (2). Except for the fact that a “closed” and an “open” operation mode has to be provided, no restrictions exist concerning the objective design of the metering head (3), respectively of the valve.

According to a preferred embodiment of the present invention, the valve is a pneumatic valve, that is a pressure-subjected valve or an electrically operated valve.

No restrictions exist in the meaning of the present invention regarding the objective design of the storage container (5), as long as the storage container is suitable for receiving a liquid having an increased viscosity.

Preferably, the storage container (5) consists of modularly arranged components that can be exchanged, if necessary. So, it is preferred that a storage container (5) comprises a cover lid (50), which can be simply opened for feeding the storage container with liquid. It is further preferred that the storage container (5) of the metering module (1, 1′) can be detached in order to purify it. An optionally existing connection pipe (32) from storage container (5) to the connection assembly element (8) can be detached for purification respectively for exchange.

The individual storage containers (5) can be different from each other with regard to their receiving capacity. Preferably, the receiving capacity of the storage containers is in the range of from 0.1 to 1.5 liters, whereby said storage containers also may have receiving capacities, which are outside of the ranges mentioned here.

For the manufacture of particular substance formulations, a large amount of a particular liquid can be needed, which then are obtained from particular storage containers that are not directly fixed on the metering module. Said liquids are then preferably directly conveyed by means of connection pipes to the respective metering head (3) respectively to the metering point (2). The use of said additional storage containers is usually preferred if the liquids to be metered have a low viscosity.

The storage containers (5) preferably consist of a chemically inert material, which is pressure-resistant and temperature-resistant. Stainless steel is suitable for example; furthermore, said stainless steel can also be provided with an inner inlay made from teflon.

Basically, the storage containers (5) can have sensors for the charging level. However, it is preferred to design the process control such that the amount of liquid to be metered is calculated for the individual metering modules (1, 1′) and can be monitored, respectively. Thereby, the process control can calculate the respective charging level and can point to a change of the metering module (1, 1′) to be taken, respectively can carry out said change by means of an automated gripper arm.

The metering module (1, 1′) and thereby in particular the storage container (5) and/or the metering point (2) can be provided with a heating device (4) and/or a cooling device and/or can be heated and/or cooled.

In a preferred embodiment, the metering module (1, 1′) comprises at least one connection pipe (32) for subjecting pressure gas to the liquid within the storage container (5) of the metering module (1, 1′).

Basically, any pressure and any gas is suitable for subjecting the liquid within the storage container (5) as long as the pressure formed above the liquid results in that a particular amount of liquid can be transferred from the storage container (5) of the metering module through the metering point (2) into a receiving container. Such pressures can e.g. be in the range of from 0.1 to 30 bar, preferably in a range of from 0.5 to 10 bar.

If the viscosity of the liquid should be too high at room temperature, then the storage container (5) and/or the metering point (2) can be heated. Inversely, it is possible to cool the liquid within the storage container and/or within the metering point if the viscosity is too low. Optionally, it is also possible to stir the liquid with stirrer (6) within the storage container (5) prior, after or during the metering actions.

It can be also meaningful to heat if a solid or a component being too viscous should be molten or should made thinner prior to the metering action. Cooling can also be meaningful for the components, which are not or not sufficiently stable at room or operation temperature. Basically, each component of the metering module that guides a liquid can be heated.

According to a preferred embodiment of the present invention, the metering station (10) comprises a unit for the pressure control. Said pressure control controls and regulates the pressure, if necessary, said pressure preferably being formed via a connection pipe (32) above the liquid within the storage container (5). Preferably, said unit for pressure control is part of the process control and/or communicates with said pressure control. Thus, e.g. the unit for pressure control can increase the pressure within the storage container if the process control detects in the scope of a calibration step that the set pressure is not sufficient to meter a sufficient amount of liquid per time unit.

In another preferred embodiment according to the present invention, the unit for pressure control also serves thereto to adjust the pressure for a pneumatic valve within the metering head (3), that is to open or to close said valve. In this circumstance, the connection pipe (30) between the connection assembly element (8) and metering head (3) is (another) pressure pipe.

In a further preferred embodiment, besides the at least one connection pipe (32) for feeding pressure gas from storage container (5), at least one further connection pipe (30) exists from connection assembly element (8) to metering head (3). Said connection pipe (30) is in a preferred embodiment an electric circuit, in case that the valve of the metering head (3) is an electrically driven valve, and is a pressure pipe, in case that the valve of the metering head (3) is a pneumatically driven valve.

No principle restrictions exist with regard to the support (7) of the metering station (10) for receiving the metering modules (1, 1′) in the meaning of the present invention, as long as the support (7) is suitable to receive at least four metering modules (1, 1′), if necessary also for different metering modules, and to position said modules into at least one direction of space.

Preferably, recesses are provided at the support (7), which engage with the respective notches of a metering module (1, 1′).

In a preferred embodiment, the support (7) has one element for receiving and/or fixing a metering module per metering module, preferably a receiving device (9) for a connection assembly element (8) as disclosed below.

In a preferred embodiment of the present invention, the support (7) for receiving the metering modules is arranged in the form of a rotatable carousel around an axial piston. In said embodiment, individual metering modules can be displaced by means of a rotation into a respective target position so that e.g. the metering point (2) is above the desired container for receiving the liquid to be metered. For example, said container can be a receiving container for samples or a test container.

According to a preferred embodiment, the metering module (1, 1′) comprises at least one connection assembly element (8) with the aid of which the metering module (1, 1′) can be engaged with a respective receiving device (9) for the connection assembly elements.

The receiving devices (9) for connection assembly elements (8) preferably are an integral or modular part of the support (7).

The connection assembly elements (8) preferably are multi-functional plug connectors, which at least have one fluidic connection element. Said fluidic connection element preferably leads to a supply pipe for pressure gas. An optional further connection element e.g. can lead to a supply with inert gas.

In a further preferred embodiment, the connection assembly element (8) has also at least one electric connection element for process control additionally to the at least one fluidic connection element.

In a further preferred embodiment, additionally to said electric connection for process control, also further electric connections are provided between the connection assembly element (8) of the metering module (1, 1′) and the receiving device (9) for the connection assembly element at the support (7), such as circuits for electric power supply, which are used in connection with heating and/or stirring devices (4, 6).

Furthermore, also means for holding and/or fixing the metering module in the receiving device can be provided in the form of the connection assembly element (8). Thus, the connection assembly element does not preferably only fulfill the functionality of a fluidic and/or electrical connection but also the mechanical support/fixing. The connection assembly element (8) thereby preferably enables the engagement respectively the detachment of a metering module (1) in or from a receiving device (9) by a single, in essential linearly directed movement. Preferably, said movement is carried out by means of an automated gripper.

In another preferred embodiment, the connecting of a metering module (1, 1′) combined with the engagement or detachment of an electrical plug connection, respectively, is automatically recognized by a process control and is analyzed.

In another embodiment, the metering module (1, 1′) may have saved specific information, e.g. regarding the liquid being present in the metering module (1, 1′) or the metering point (2), which is inserted into the metering head (3). Preferably, said information is automatically recognized by the process control during the insertion of the metering module into the support (7) or shortly after the insertion. Preferably, said specific information is saved in a magnetic saving element, which is positioned in the region of the connection assembly element (8).

In another preferred, the metering module (1, 1′) is characterized by a bar code, and the metering station (10) comprises a respective reading device for the identification of the bar code. This embodiment independently enables the identification of the metering module from an electric connection. Preferably, the control of the reading device is connected with the process control.

In carrying out particular metering processes regarding highly viscous liquids, a heating, cooling or stirring of the liquid being present in the storage container may be required or may be meaningful. Hereby, the modular design of the individual metering modules is preferred, since herewith for example the heating device (4) or the stirring device (6) can be added in a simple manner to a metering module (1, 1′), or can be detached from this, or can be exchanged between two modules. Preferably, the heating/cooling (4) has the shape of a casing and is arranged around the storage container (5) of the metering module (1, 1′) in thermal contact.

In a preferred embodiment of the present invention, the metering station comprises a waste container for receiving liquid from at least one metering module. In this embodiment, the amount of liquid metered into the waste container is not gravimetrically determined. Accordingly, the waste container preferably is not arranged on a scale (12). However, it is possible by means of the opening times of the valve of the metering valve, of the inner diameter of the metering point and the type of the substance to be metered, to estimate the liquid amount metered into the waste container. The metering of liquid from one or several metering module/modules into the at least one waste container may e.g. serve for rinsing foulings out from the metering point, which may be formed during the evaporation of solvent from the metering point.

In a preferred embodiment, the metering station (10) comprises also at least one test container besides at least one receiving container for samples. Said test container is distinguished from the receiving container for samples thereby that it does not serve for the preparation of a substance formulation but rather is employed in the calibration step, which is described in more detail below, prior to the actual substance formulation in order to determine the metering parameter of at least one metering module (1, 1′). Contrary to the content of a receiving container for samples, the content of a test container is not (further) used as a final product at the end of the process according to the invention, however is professionally disposed. Contrary to the waste container, the test container preferably is located on a scale (12), since with the test container a liquid amount that is to be filled in according to demand, has to be compared with an actually metered amount of liquid.

In another preferred embodiment, the metering station (10) according to the invention has a sensor device with the aid of which the position and/or the positioning of metering heads (3) respectively metering points (2) can be determined absolutely and/or relatively to the receiving container for samples and/or the scale and/or the housing for covering. Preferably, the sensor device communicates with the central process control.

A process according to the invention for the high throughput metering of highly viscous liquids respectively for the high throughput formulation of highly viscous substances comprises at least the following steps:
(i) providing at least one liquid having an increased viscosity in at least one metering module (1, 1′) comprising at least storage container (5), metering head (3) and metering point (2);
(ii) charging a support (7) with at least four metering modules (1, 1′), wherein step (ii) temporarily can be carried out prior to step (i), and in each case as result of steps (i) and (ii) at least one metering module (1, 1′) comprising a liquid having an increased viscosity must be present in a support (7) together with at least three first metering modules (1, 1′);
(iii) automatedly positioning at least one metering module (1, 1′) comprising a liquid having an increased viscosity via at least one test container on a scale (12);
(iv) carrying out a calibration step with the at least one metering module (1, 1′) from step (iii) comprising a liquid having an increased viscosity for determining the amount of said liquid that is metered per time unit in the opened state of metering head (3) from storage container (5) through metering point (2);
(v) automatedly positioning at least metering module (1, 1′) from step (iii) via at least one receiving container for samples on a scale (12);
(vi) carrying out at least one targeted metering step in which a predetermined fraction of the total liquid to be metered into a receiving container for samples or the total predetermined amount of liquid from metering module (1, 1′) from step (iii) is metered into the receiving container for samples on the scale (12).

Steps (v) and (vi) can be carried out as often as required and for an arbitrary number of metering modules (1, 1′) and/or receiving containers for samples. Always, step (iv) is carried out prior to the first of steps (v) and (vi), which as often as required can be arbitrarily carried out.

In a preferred embodiment, the number of target-metering steps (vi), that is of metering pulses (see examples below) is dependent on the total amount of liquid to be metered.

One advantage of the process according to the invention consists therein that the metering parameter, that is the amount of liquid being metered per time unit through the opened valve is determined prior the actual (target) metering action. Merely in principle, a determination of the metering parameters would also be possible during the actual target-metering step, e.g. by metering firstly a low amount of liquid into the receiving container for samples. Particularly in case of highly viscous liquids and in case of use of a multitude of different liquids, as it is usual in the scope of the high throughput formulation, it is however not always possible to meaningful (pre)determine what a “low amount of liquid” is in the particular case. So, for example, it would not be acceptable that in a complex formulation already ten components were metered, however, the eleventh component is metered in the first target-metering step already exceeding the totally scheduled amount, since the eleventh component that was not calibrated prior to the metering is essentially less viscous than this is anticipated by the process control. Such a scenario is avoided in the process according to the invention, since the calibration step occurs prior to the target-metering step.

In a preferred embodiment of the process according to the invention, all metering modules (1, 1′), which are in the support (7) are subjected to a calibration step (iv) before in total the first target-metering step (vi) is carried out.

In a preferred embodiment, the calibration step (iv) comprises at least the following steps:
(a) metering an amount of liquid predetermined by the process control into a test container onto a scale (12) by opening metering head (3), that is preferably of a metering valve for a technically meaningful cycle time that was predetermined by the process control;
(b) weighing the actually metered amount;
(c) determining the actually metered amount of liquid (“metering parameter”) per time unit by using the measured value from (b) by the process control and comparison of the thus determined metering parameter with a reference value that was predetermined by the process control, if necessary;
(d) adjusting the parameter of the process control, if necessary, that is in particular pressure over the liquid, type of metering point as well as temperature in order to achieve the referenced value as well as repeating steps (a) to (c), if necessary.

In a preferred embodiment of the process according to the invention, the target-metering step (vi) is divided into the at least following sub-steps:
(vi′) carrying out a first target-metering step in which a predetermined fraction of the total liquid to be metered into a receiving container for samples is metered into a receiving container for samples on a scale, and in fact by using the amount of liquid to be metered per time unit as was determined in calibration step (iv);
(vi″) weighing the amount of liquid actually metered in step (vi′) and comparing with one reference value set by the process control, if necessary with correction of the amount of liquid metered per time unit;
(vi′″) carrying out a second target-metering step in which the missing balance regarding the total amount of the liquid to be totally collected is metered, in turn by using the amount of liquid per time unit, which is determined in calibration step (iv), corrected as in step (vi″), if necessary.

The predetermined fraction of the total amount to be metered in step (vi) or in (vi′) is in the range of from 10 to 99% of the total amount, preferably in the range of from 40 to 95% of the total amount to be metered, further preferred in the range of from 50 to 80% of the total amount to be metered.

In a preferred embodiment, target-metering steps are carried out in parallel for at least two different liquids in at least two different metering modules (1, 1′), which are fed to at least two different receiving containers for samples.

With regard to step (ii), it is preferred that the support (7) is automatedly provided in a simple manner by a unit for positioning together with the at least four metering modules (1, 1′). Preferably, the last movement of the unit for positioning, which engages the metering module (1, 1′) with the support (7) and retains it, is an essentially linear, single movement.

In a preferred embodiment, in regular distances, small amounts of liquid are transferred from the individual metering modules (1, 1′) into a waste container, e.g. in order to avoid concentration changes or the formation of separations and/or foulings within the metering point (2). The concentration change in the liquid being present in the metering point caused by the evaporation of solvent, if the case may be, as well as a separation of products having a higher viscosity or solid products in the metering point, is not desired since herewith the accuracy of the metering process can be affected. In another process step, the metering of liquid into a waste container is carried out after the change of individual elements of the metering modules (1, 1′), for example in order to clean the metering head (3) and/or an exchanged metering point (2) and/or to check for functional efficiency.

In the calibration step described above, preferably test meterings are carried out in which the parameters of the metering module (1, 1′)—such as the pressure or the temperature in the storage container (5), or the free inner diameter of the metering point (2)—are varied in predetermined limits, whereby the thereby metered amount of liquid is gravimetrically recorded.

Thereby, the individual test meterings preferably occur in a test container being located on a scale. The test container may—in the same manner as the receiving containers for samples—be moved by means of a unit for positioning from one location onto the scale (12) and (back) to a location.

In one embodiment of the process according to the invention, the metering parameter that is determined by means of the calibration step (iv), is directly used for carrying out the actual target-metering steps. If a multitude of different substance formulations is prepared with the different liquids, then it is time saving to once calibrate all liquids and then to possess a reliable metering parameter for the multitude of target-metering steps. This is more effective than to newly determine the metering parameter prior to each individual measuring for each individual liquid.

If parameters of the metering module (1, 1′) such as temperature, type of the metering point, inner pressure within the storage container etc. have been respectively selected, then the accuracy of the metering, that is the deviation of a predetermined reference value depends mainly on the cycle times of the valve at the metering head. Technically realistic are cycle times of 100 milliseconds and more. Accordingly, the above mentioned parameters of the metering module or if necessary other parameters must be varied if the aspired fraction of the total amount can not be metered within a technically meaningful cycle time, that is in a time that is more than e.g. 100 milliseconds.

In the above mentioned process step (vi″), the actually metered liquid amount is determined with aid of a scale and is compared with a reference value, that is the aspired fraction of the total amount to be metered. In case of a deviation of the actually metered amount of liquid being too high from the calculated amount of liquid, the calibration can be corrected in the manner of a feedback mechanism, if necessary. Through this, the accuracy for the second (and preferably last) target-metering step is correspondingly high so that that in total a high metering accuracy is achieved.

In another embodiment of the process, calibration step (iv) is repeated if in step (vi″) the deviation between the actually metered amount of liquid in first step and the reference value should be more than a predetermined, maximal deviation that has to be determined before. This means that the process control does not only control individual metering actions, but can also be employed for the monitoring of the system.

Although the present invention in particular concerns the metering of liquid components into a receiving container for samples, according to an embodiment of the process according to the invention, also solid components can be metered simultaneously or prior to or afterwards.

In a preferred embodiment of the process according to the invention, a complete emptying of a storage container is recognized also by the process control if no increase in weight should occur when carrying out metering actions, however, a pressure drop within the inert gas pipe has to be registered. In this case, the metering valve is automatically closed.

With regard to the processing of the signal of the scale (12), a configuration is preferred through which the measured signals are registered in a state being as unfiltered as possible, and are transferred to the process control. Through this, it is at first possible that in very short times weight changes can be detected and can be determined. The measured signals registered by the scale (12) are preferably transferred with a transfer rate of 25 Hz to the process of control. The process control takes the analysis of the signals for the determination of weight and stability of the weight values transferred by the scale, and is thereby enabled to react particularly fast to a system change. The filter parameters that are usually impressed by the scale on the weighing signals are carried out in case of the present invention in a dynamic manner by means of the process control.

A more detailed description of the invention can also be depicted from the drawings presented in the figures, which are explained in more detail in the following.

### BRIEF DESCRIPTION OF THE FIGURES

FIG. 1.a shows a top view of a metering module (1)

FIG. 1.b shows the metering module from FIG. 1.a in a rotated view;

FIG. 2 shows a support (7) according to one embodiment of the present invention;

FIG. 3 shows a parallel arrangement of three metering stations (10);

FIG. 4 exemplarily shows the arrangement of the (gas) supply systems for a particular embodiment for the metering station (10);

FIG. 5.a shows the schematic design of a metering module with stirrer;

FIG. 5.b shows a top view of a carousel-shaped support (7) according to a particular embodiment of the present invention;

FIG. 6 shows a metering station (10) according to a particular embodiment of the present invention;

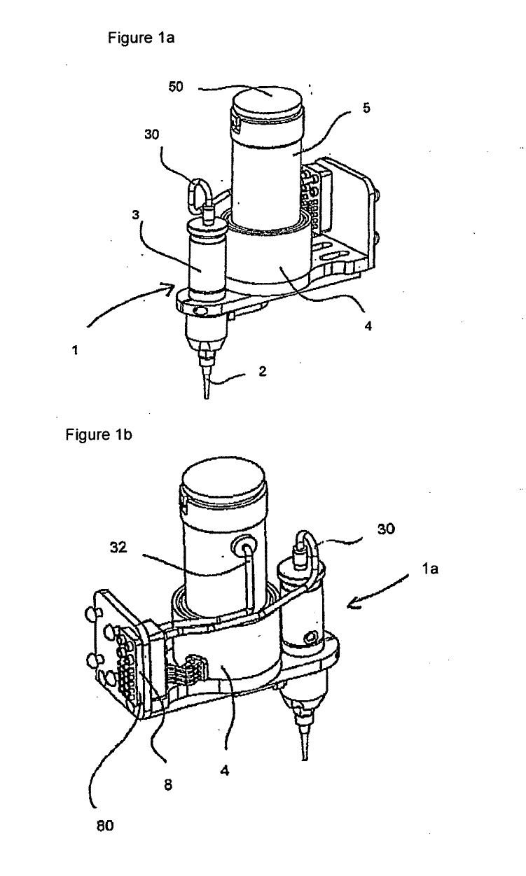

FIG. 1.a shows a top view of a metering module (1) comprising a storage container (5) comprising cover lid (50) and a metering head (3) comprising an exchangeable metering point (2). In said embodiment, metering head (3) comprises a pneumatic shift valve comprising a pressure gas feed (30). In this embodiment, the heating (4) is jacket-shapedly arranged around the storage container (5). In other embodiments, the heating comprises the whole metering module (1).

FIG. 1.b shows the metering module from FIG. 1.a in a rotated view, wherein the backside of the connection assembly element (8) as well as the pipes (30) and (32) from metering head (3) and from storage container (5) to the connection assembly element (8) each can be recognized. In this embodiment, both pipes are pressure gas pipes, on the one hand for subjecting pressure gas to the liquid within the storage container, and on the other hand for the control of a pneumatic valve within the metering head (3).

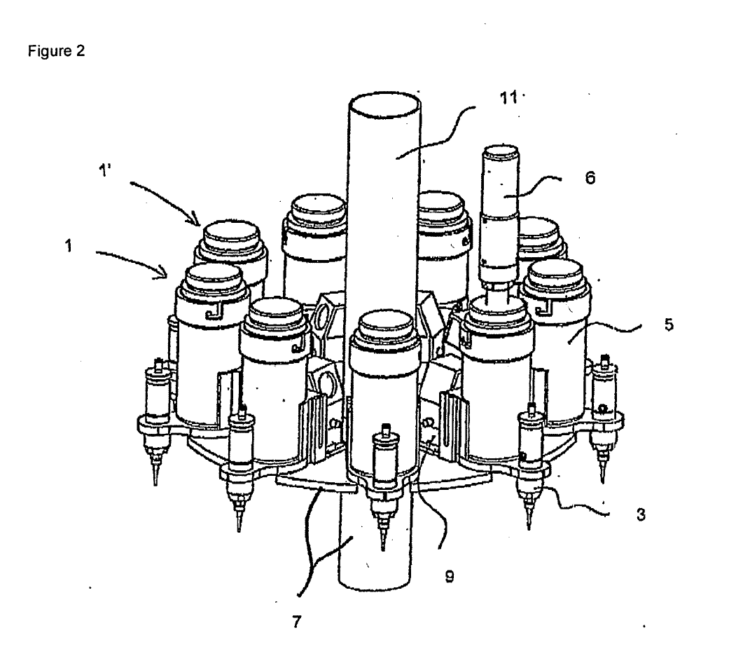

FIG. 2 shows a carousel-shaped support (7) that, in this particular embodiment, is provided with nine metering modules (1, 1′). Any arbitrary higher amount of metering modules is conceivable for this and for all other embodiments of the invention, e.g. more than 12, more than 24 or more than 48. As can be seen in FIG. 2, the connection assembly elements (8) of metering modules (1, 1′) are connected with the receiving devices (9) of support (7). Thus, each metering module is fluidly connected with a central fluid supply, e.g. a central pressure gas supply, as well as electrically with the central process control. This electric connection allows the central process control to “recognize” the specific metering module. One of the nine metering modules from FIG. 2 is provided with a stirrer (6).

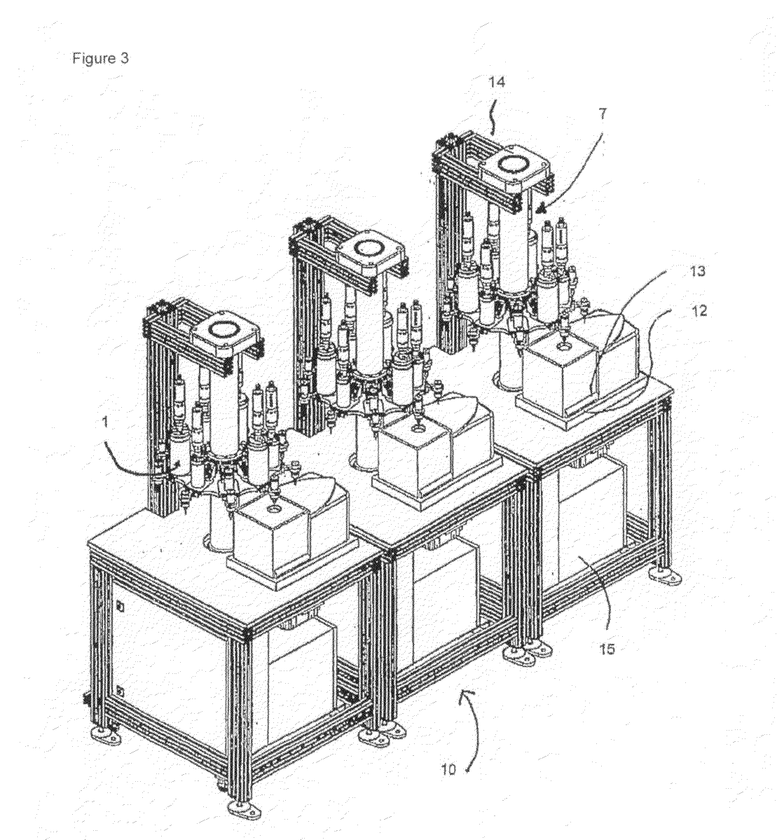

FIG. 3 shows a parallel arrangement of three metering stations (10). Each individual metering station has a rack (14) for receiving a support (7), which is provided with metering modules (1, 1′), respectively, a scale (12) having a movable cover (13) and a control device (15), which for example can comprise the central process control.

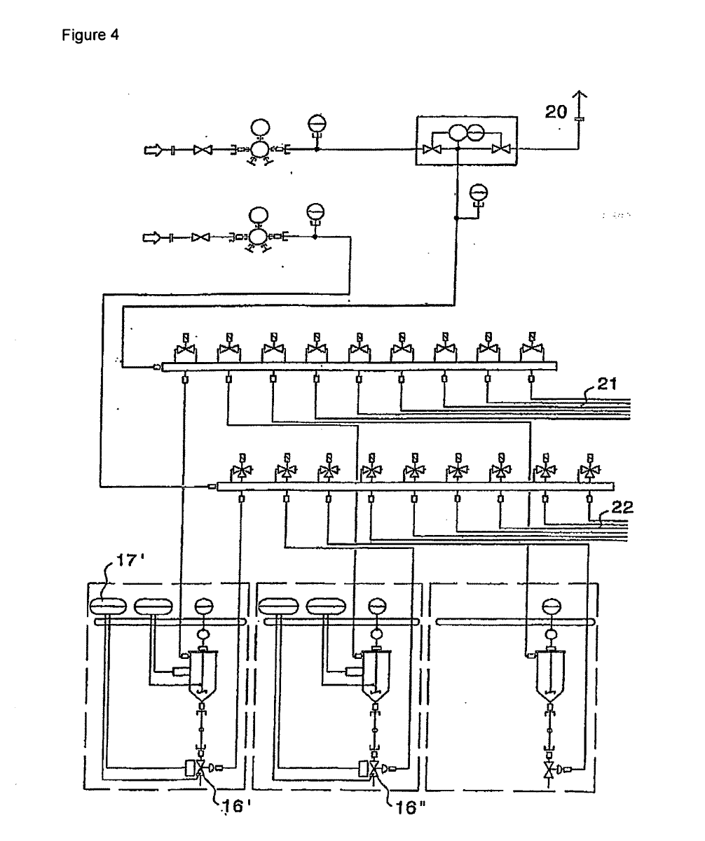

FIG. 4 shows the schematic design of a particular embodiment of the metering station (10) according to the invention. Thereby, the metering station comprises two different gas supply systems, which each comprise inert gas pressure pipes (21) and pressure air pipes (22). The inert gas pressure pipe system is in connection with storage containers (5), and the pressure air pipe system is in connection with magnet valves, by means of which the pneumatically driven metering valves (16′, 16″) are controlled within the metering heads (3). It is preferred that the individual storage containers of the metering modules are individually controlled and can be charged with different pressures of inert gas. Further preferred is the heating of the metering valve by heating (17′).

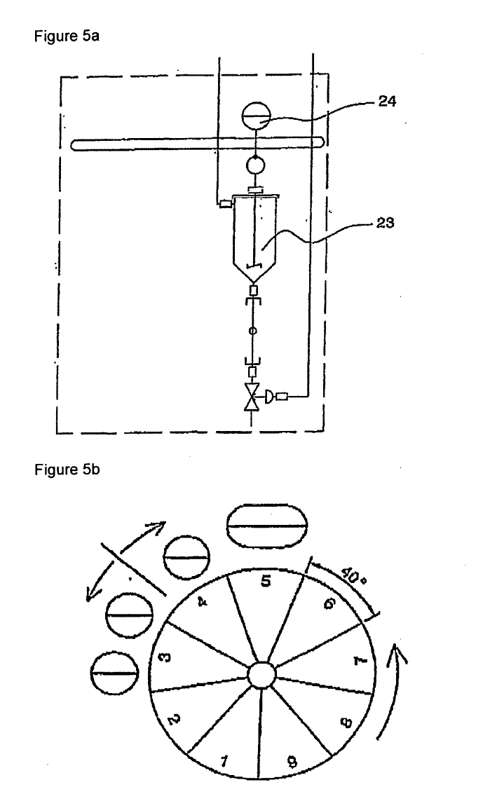

FIG. 5.a shows the schematic design of a metering module comprising stirrer (23) and driving motor (24) for the stirring device.

FIG. 5.b shows a top view of a carousel-shaped support (7). The numerals in the figure characterize the individual positions at which the metering modules (1, 1′) are attached. In the presented example, the support (7) can be provided with nine metering modules (1, 1′). The turning platform of the support can be rotated from the starting position both for 180° in clockwise direction and also for 180° against the clockwise direction around the axial center piston.

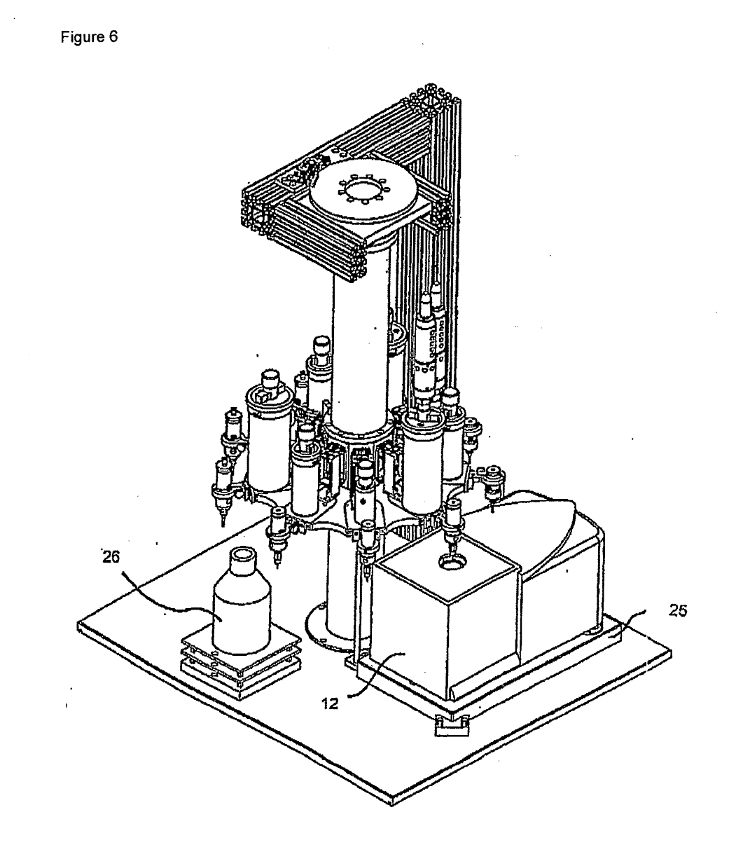

FIG. 6 shows a metering station (10) having a carousel-shaped support (7), wherein the support is provided with different metering modules (1, 1′). In the presented embodiment, the individual metering modules also have a mechanic connection to the carousel-shapedly constructed sample plate of support (7). In a preferred embodiment, said mechanic connection is additionally provided to the connection assembly element (8). Furthermore, scale (12) is on an absorption plate (25) in order to shield the scale as good as possible against disturbances caused by vibrations of the surrounding. Furthermore, also a waste container (26) is presented, which is provided for receiving liquid, e.g. immediately prior to the positioning of the respective metering module above a receiving container for samples.

In a preferred embodiment of the process according to the present invention, different metering sequences are automatically realizable by means of the process control, also sequences of target-metering steps, wherein the selection of the precisely used metering sequence inter alia depends on the total amount of liquid to be metered. The selection of the metering sequence is not or at least not exclusively dependent on the viscosity of the liquid to be metered.

The portioning of the liquid to be metered preferably takes place in one to six or more sub-quantities. The term “metering pulse” DP as used in the following refers to such an individual portion. A sequence is composed of a sequence of metering pulses DP₁, DP₂, DP₃ . . . , wherein the simplest sequence consists of a single metering pulse DP₁.

The duration of an individual metering pulse is determined by the valve opening time of the metering valve, Δt. Preferably, the opening time is selected such that the flow rate (amount of liquid to be metered per time unit) is in the linear range when metering the liquid. The linearity of the flow rate can be monitored in respective calibration steps.

In the manufacture of the substance formulations, the metering pulses and the thereby metered weight quantities are preferably used for calibrating the metering system, wherein it may be required in the metering of small total amounts of liquid to carry out the process with a lower number of metering pulses.

The following exemplarily selected weight amounts refer to a system in which the metering point and the metering pressure are predetermined and the flow rate has a value of 1 g/s: if the total amount of liquid to be metered is above 2 g, then a metering sequence is carried out by the control program that includes four or more metering pulses. If the total amount of substance to be metered is below 2 g, then a metering sequence is carried out, which includes four or less metering pulses.

In order to achieve a high accuracy in the whole metering when using a variable number of metering pulses, at the start of each individual sequence two metering pulses are released into the sample container, respectively, controlled via the valve opening times, wherein the metering process preferably runs as follows: At first, the first two sub-quantities are successively metered independently from the total amount to be metered into the sample container at two relatively short valve opening times Δt₁ and Δt₂. In general, the valve opening times have precisely determined values, wherein Δt₁, is in the range between 100 and 1,000 ms and Δt₂ is in the range of from 100 to 1,500 ms. The value of Δt₁ is different from the value Δt₂ wherein for the manufacture of different substance formulations usually the same value pair Δt₁, and Δt₂ are used for the control of the valve opening time for the first two metering steps, respectively.

The following values show an example in order to describe the process according to the invention in more detail: Carrying out two successive metering pulses with the valve opening times Δt₁=200 ms and Δt₂=400 ms. The period for registration of the weight increase by means of the process control is approximately 1,000 to 1,500 ms per metering pulse. Consequently, the double pulse-like metering sequence inclusive the registration of the weight values is approximately 2,600 to 3,600 ms (wherein the calculation is carried out as follows: Δt₁+Δt₂+2× registration time).

By means of the process control, the values recorded in the double pulse-metering are used for the determination of the actual calibration. While considering the actual calibration, the valve opening time Δt₃ is calculated, which is selected for the third metering step.

A metering of the total amount of liquid to be metered by a three-step sequence, that is of three metering pulses, is preferably employed when the total amount of substance to be metered is in the range of from 0.8 to 2 g.

The metering when using a four-step sequence is preferably used for total amounts, the weight of which is in the range of from 1.0 and 2 g.

For metering a liquid amount whose total amount is in the range of from 0.2 to 0.8, a modified three-step sequence is used, in which the receiving container for samples is changed prior to the release of the third metering pulse. In this manner, by means of the release of two metering pulses into a test container, an actual calibration is carried out which then is used for the delivery of the third metering pulse—now again into the receiving container for samples.

Concerning the accuracy to be achieved, it is particularly advantageous in this process that the fine metering in connection with a recalibration is carried out only before achieving the target amount of liquid to be metered. Among other things, this is due to the fact that the internal pressure within the storage container depends on the level which changes during the metering and also that the minimal temperature fluctuations are compensated within the system.

With a flow rate of 1 g/s, the total amount to be metered by means of the here described metering process can be metered within a metering accuracy of approximately 1 to 2 mg. With a flow rate of 0.1 g/s, the total amount can be metered by means of the here described metering process with a metering accuracy of approximately 0.1 to 0.2 mg.

### LIST OF REFERENCE NUMERALS

1, 1′—metering module
2—(exchangeable) metering point
3—metering head
30—connection pipe
32—connection pipe
4—heating device
5—storage container
50—cover lid
6—stirrer
7—(carousel-shaped) support
8—connection assembly element
80—plug connections for electric circuits and gas pipes
9—receiving device for connection assembly element
10—metering station
11—axial piston
12—scale
13—movable cover
14—rack
15—supply unit/control
16′, 16″ valve at the metering head
17′, 17″—electric connection circuits for driven stirrer
18″—valve
20—exhaust air
21—inert gas supply pipes
22—pressure gas supply pipes
23—shaft for stirrer
24—driven motor for stirring device
25—absorption plate
26—waste container

1-15. (canceled)

16. A Metering station (10) for metering at least one liquid having an increased viscosity comprising:
at least four metering modules (1, 1′) comprising at least one metering module comprising a liquid having an increased viscosity and comprising at least two metering modules comprising different liquids;
at least one support (7) for receiving the at least four metering modules (1, 1′), wherein the support simultaneously may be an automated unit for positioning;
at least one automated unit for positioning the at least four metering modules, which either can be the support (7) or a unit for positioning independent from said support;
at least one scale (12) for receiving receiving containers for samples or test containers; and
a process control,
wherein each metering module (1, 1′) is connected with the support (7) via the connection assembly element (8).

17. The metering station (10) of claim 16, wherein the independent unit for positioning is a gripping device.

18. The metering station (10) of claim 16, wherein at least one metering module (1, 1′) comprises a metering point (2), a metering head (3) and a storage container (5), wherein metering point, metering head and storage container are in fluidic connection.

19. The metering station (10) of claim 18, wherein the metering point (2) is exchangeable.

20. The metering station (10) of claim 18, wherein the metering head (3) is a valve or comprises a valve, which can be electrically or pneumatically controlled.

21. The metering station (10) of claim 18, wherein the storage container (5) and/or the metering point (2) and/or the metering head (3) comprises or comprise a heating device.

22. The metering station (10) of claim 18, wherein the metering module (1, 1′) comprises at least one connection pipe (32) for subjecting the liquid within the storage container (5) of the metering module (1, 1′) to a pressure gas.

23. The metering station (10) of claim 18, wherein said metering station comprises a unit for pressure control.

24. The metering station (10) of claim 18, wherein each metering module (1, 1′) comprises a connection assembly element (8), and wherein the support (7) comprises a receiving device (9) for said connection assembly element (8) per metering module

25. The metering station (10) of claim 22, wherein besides the at least one connection pipe (32) for delivery of pressure gas to the storage container (5), at least one further connection pipe (30) from connection assembly element (8) to metering head (3) is provided, which may be a pressure gas pipe or an electric circuit.

26. The metering station (10) of claim 16, wherein the support (7) for receiving the metering modules (1, 1′) is arranged as a rotatable carousel around an axial piston.

27. A process for high throughput metering of liquids having an increased viscosity and for high throughput formulation of substances, the process comprising at least the following steps:
(i) providing at least one liquid having an increased viscosity in at least one metering module (1, 1′) comprising at least storage container (5), metering head (3) and metering point (2);
(ii) charging a support (7) with at least four metering modules (1, 1′), wherein step (ii) can also be temporarily carried out prior to step (i), and in any case as result of steps (i) and (ii) at least one metering module (1, 1′) comprising at least one liquid having an increased viscosity must be provided in a support (7) together with at least three further metering modules (1, 1′);
(iii) automatedly positioning at least one metering module (1, 1′) comprising a liquid having an increased viscosity above at least one test container on a scale (12);
(iv) carrying out a calibration step with which at least one metering module (1, 1′) from step (iii) comprising a liquid having an increased viscosity is metered for the determination of the amount of said liquid that is metered per time unit in opened condition of said metering head (3) from storage container (5) through metering point (2);
(v) automatedly positioning at least metering module (1, 1′) from step (iii) via at least one receiving container for samples on a scale (12);
(vi) carrying out at least one target-metering step in which a predetermined fraction of the liquid to be totally metered into a receiving container for samples, or the total predetermined liquid amount, from metering module (1, 1′) from step (iii) is metered into the receiving container for samples on scale (12),
wherein steps (v) and (vi) may be arbitrarily often carried out and for any number of metering modules (1, 1′) and/or receiving containers for samples, and always step (iv) is carried out before steps (v) and (vi), which arbitrarily often can be carried out, if necessary.

28. The process of claim 27, wherein in step (ii) the support (7) is automatedly charged by means of a unit for positioning with the at least four metering modules (1, 1′), wherein the last movement of the unit for positioning, which brings each of the metering modules (1, 1′) in engagement and connection with the support (7), is in essential a linear, simple movement.

29. The process of claim 27, wherein the calibration step (iv) comprises at least the following steps:
(a) metering an amount of liquid predetermined by the process control into a test container on a scale (12) by opening metering head (3), that is preferably of a metering valve, for a technically meaningful cycle time, which is predetermined by the process control;
(b) weighing the actually metered amount;
(c) determining the amount of liquid actually metered per time unit (“metering parameter”) by using the measured value from (b) by the process control and comparing the so determined metering parameter with a predetermined reference value, which is predetermined by the process control, if necessary;
(d) optionally adjusting the parameter of the process control, that is in particular pressure over the liquid, type of metering point and temperature in order to achieve the reference value, repeating steps (a) to (c), if necessary.

30. The process of claim 27, wherein the target-metering step (vi) comprises at least the following sub-steps:
(vi′) carrying out a first target-metering step in which a predetermined fraction of the liquid to be totally metered into a receiving container for samples is metered into a receiving container for samples on a scale, and actually by using the amount of liquid to be metered per time unit, as determined in calibration step (iv);
(vi″) weighing the amount of liquid actually metered in step (vi′) and comparing with a reference value predetermined by the process control, if necessary with a correction of liquid metered per time unit after the comparison;
(vi′″) carrying out a second target-metering step in which the missing balance of the total amount of liquid to be totally collected is metered, in turn by using the amount of liquid determined in calibration step (iv) per time unit, corrected as in step (vi″), if necessary.
